(19) United States
(12) Patent Application Publication
(10) Pub. No.: US 2018/0288179 A1
(43) Pub. Date: Oct. 4, 2018

(54) PROXY FOR SERVING INTERNET-OF-THINGS (IOT) DEVICES

(71) Applicants: Randeep S. BHATIA, Green Brook, NJ (US); Bhawna GUPTA, Basking Ridge, NJ (US); Tirunell V. LAKSHMAN, Morganville, NJ (US); Shreyasee MUKHERJEE, Highland Park, NJ (US); Dragan SAMARDZIJA, Highlands, NJ (US)

(72) Inventors: Randeep S. BHATIA, Green Brook, NJ (US); Bhawna GUPTA, Basking Ridge, NJ (US); Tirunell V. LAKSHMAN, Morganville, NJ (US); Shreyasee MUKHERJEE, Highland Park, NJ (US); Dragan SAMARDZIJA, Highlands, NJ (US)

(21) Appl. No.: 15/477,854

(22) Filed: Apr. 3, 2017

(51) Int. Cl. H04L 29/08; H04L 29/06

(52) U.S. Cl. CPC H04L 67/28; H04L 69/16; H04L 69/22; H04L 67/12

(57) ABSTRACT

An Internet-of-Things (IOT) proxy includes storage hardware configured to store first and second state information. The first state information defines first contexts for flows associated with a plurality of IoT devices. The plurality of electronic devices have established a corresponding plurality of first sessions that are terminated by the IoT proxy. The second state information defines second contexts for the flows associated with the plurality of IoT devices. The second state information is associated with a second session that has been established between the proxy and a server or an other electronic device. The IoT proxy also includes computing hardware configured to modify headers of packets associated with the IoT devices based on at least one of the first state information or the second state information. In some cases, the IoT proxy is implemented as a virtual network slice in a network function virtualization (NFV) architecture.

### BACKGROUND

The Internet-of-Things (IoT) refers to the internetworking of physical devices such appliances, vehicles, buildings, and other items that are embedded with electronics, software, sensors, actuators, and network connectivity that enable the devices to collect and exchange data over the Internet. In order to support the IoT, the capabilities of conventional wireless communication networks are moving beyond enabling wireless broadband service to include support for narrowband IoT devices, which require low latency communication and have limited battery life, computing resources, memory, and wireless range. The density of IoT devices is expected to be significantly larger than the density of conventional user equipment, e.g., a deployment of millions of IoT devices per square kilometer is anticipated.

The overhead required to connect such a large number of IoT devices to the network can pose a significant burden on the available resources of the air interface. For example, IoT devices commonly perform uplink initiated short data transfers that are initiated by an IoT device and used to transmit a short amount of data, e.g., a single packet of 100 bytes. The short data transfer should be fast, e.g., the transfer should complete within 1 ms. However, transmitting the packets according to conventional protocols such as Transmission Control Protocol (TCP) or User Datagram Protocol (UDP) requires comparatively large headers and, in the case of TCP, a time-consuming three-way handshaking protocol. For example, a TCP header includes 40 bytes and a UDP header includes 48 bytes. Performing the three-way handshaking protocol and transmitting the TCP or UDP headers for uplink initiated short data transfers from IoT devices significantly increases latency of the data transfers and increases the percentage of the air interface resources that are consumed by overhead.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system that provides wireless connectivity to Internet-of-Things (IOT) devices according to some embodiments.

FIG. 2 is a block diagram of a network function virtualization (NFV) architecture according to some embodiments.

FIG. 3 is a block diagram that illustrates protocol stacks for interfaces between entity in a wireless communication system that provides wireless connectivity to one or more IoT devices according to some embodiments.

FIG. 4 is a block diagram that illustrates interfaces that are used to support D2D communication in a wireless communication system 400 according to some embodiments.

FIG. 5 is a block diagram of a shim header that is appended to packets transmitted between IoT devices and an IoT proxy according to some embodiments.

FIG. 6 is a block diagram that illustrates a packet translation process performed by an IoT proxy according to some embodiments.

FIG. 7 is a flow diagram of a method of translating uplink packets received from an IoT device to be forwarded to an IoT server according to some embodiments.

FIG. 8 is a flow diagram of a method of translating downlink packets received from an IoT server to be forwarded to an IoT device according to some embodiments.

### DETAILED DESCRIPTION

Asynchronous, connectionless, low latency, low signaling, and low overhead access for IoT devices is supported by a network architecture that implements an IoT proxy to receive uplink packets from IoT devices according to a first protocol and translate the received packets to a second protocol for transmission to one or more servers according to the second protocol. The IoT proxy receives downlink transmissions from the servers according to the second protocol, translates the received packets to the first protocol, and then transmits the packets to IoT devices according to the first protocol. In some embodiments, the first protocol is a lightweight version of the second protocol that is used to establish a transport session between the IoT proxy and a server.

The uplink packets received from the IoT devices include a payload and a shim header formed according to the first protocol. Some embodiments of the shim header include a device identifier that is assigned to the IoT device from a pool of device identifiers maintained by the IoT proxy and a server identifier, which can be assigned to the server from a pool of server identifiers maintained by the IoT proxy. The server identifier can also identify another IoT device for device-to-device (D2D) communication, as discussed herein. In some embodiments, the pool of server identifiers is maintained separately for each IoT device so that the same server identifier can be used to identify different servers (and vice versa) that are associated with different IoT devices. The shim header can also include other information such as a message type, a flag to indicate whether the uplink packet should be reliably transmitted, a flag to indicate whether receipt of the uplink packet is acknowledged by the IoT proxy, a flag to indicate whether an integrity check is to be performed, a flag to indicate whether a rate control setting is in use, and (optionally, depending on values of the corresponding flags) a retransmission count, a rate setting, a sequence number, an acknowledgment number, and integrity check information. The uplink packets are conveyed from the base stations that serve the IoT devices to the IoT proxy by tunnels that are shared by the IoT devices served by each base station. Some embodiments of the IoT proxy support device to device (D2D) communications between IoT devices, in which case the second protocol is the same as the first protocol.

The IoT proxy terminates the sessions that are used to convey data in the uplink packets received from the IoT devices to the servers indicated by the server identifier in the header of the packet. Embodiments of the IoT proxy that support D2D communications serve as a relay for the D2D communication sessions. The IoT proxy maintains information mapping the device identifiers to the globally unique identifiers of the IoT devices and, if the IoT proxy assigns server identifiers to the servers from a pool, the IoT proxy maintains information mapping the server identifiers to the servers. The IoT proxy also maintains state information to define contexts for each flow associated with the IoT devices. For example, the state information for a context can include the globally unique identifier of the IoT device, sequence numbers for an automatic repeat request protocol, a security context, and other state information used to form packets according to the second protocol, such as TCP state information. In response to receiving an uplink packet from an IoT device via a tunnel to a corresponding base station, the IoT proxy removes the shim header (or modifies the shim header in the case of D2D communications) from the packet and extracts the payload, which is placed into the payload of a new uplink packet. The IoT proxy appends a header including routing and transfer information to the new uplink packet, which is sent over a connectionless (e.g., UDP) or connection oriented (e.g., TCP) protocol to a destination server indicated in the shim header. The IoT proxy generates the header based on the state information for the IoT device and state information for the server connection. For downlink packets, the IoT proxy removes headers formed according to the second protocol from the downlink packet and creates a new downlink packet including the payload extracted from the downlink packet. The IoT proxy appends a shim header to the new downlink packet and forwards the new downlink packet to the IoT device via the tunnel between the IoT proxy and the base station that serves the IoT device. In some embodiments, the shim header is formed using state information for the IoT device, such as sequence numbers, a security context, and the like.

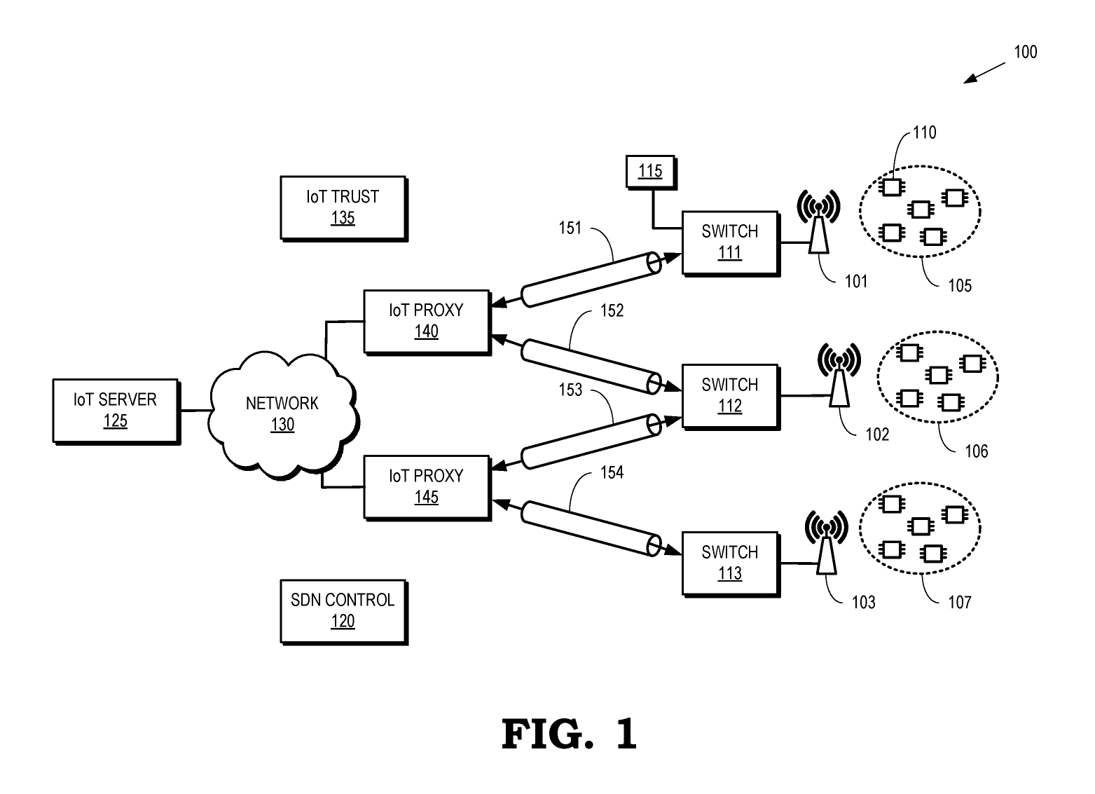

FIG. 1 is a block diagram of a wireless communication system 100 that provides wireless connectivity to Internet-of-Things (IOT) devices according to some embodiments. The wireless communication system 100 includes base stations 101, 102, 103 (collectively referred to herein as “the base stations 101-103”) that provide wireless connectivity within corresponding geographic areas or cells 105, 106, 107 (collectively referred to herein as “the cells 105-107”). The cells 105-107 include IoT devices 110. Only one IoT device 110 is indicated by a reference numeral in the interest of clarity. The IoT devices 110 can include physical devices such as appliances, vehicles, buildings, and other items that are embedded with electronics, software, sensors, actuators, and network connectivity that enable the IoT devices 110 to collect and exchange data over the Internet using the connectivity provided by the wireless communication system 100 via the base stations 101-103.

The base stations 101-103 are connected to switches 111, 112, 113, which are collectively referred to herein as “the switches 111-113.” Some embodiments of the switches 111-113 are implemented using software defined networking. For example, the switches 111-113 can implement data plane functionality to process incoming packets based on rules defined in a flow table 115. The flow table 115 is implemented external to the switch 111. However, flow tables can be implemented either internally or external to the corresponding switches 111-113. In the interest of clarity, a single flow table 115 is shown in FIG. 1 but each of the switches 111-113 implements or has access to a corresponding flow table. An SDN control unit 120 implements control plane functionality that is used to configure the switches 111-113, e.g., by providing information to configure the flow table 115. Consolidating the control plane functionality for the switches 111-113 into the SDN control unit 120 allows the wireless communication system 100 to support dynamic resource allocation, which can significantly reduce the costs associated with establishing and maintaining the wireless communication system 100 when compared to a conventional network. SDN also allows for global optimization that is not possible with local routing protocols. In the interest of clarity, individual connections between the SDN control unit 120 and the switches 111-113 are not shown in FIG. 1.

An IoT server 125 provides services to the IoT devices 110 via a network 130. In some circumstances, the IoT server 125 is the originating source or the final destination for packets transmitted between the IoT devices 110 and the IoT server 125. However, in other circumstances, the IoT server 125 is an intermediate destination that receives packets from the IoT devices 110 and forwards them to a destination in the network. The IoT server 125 can also receive packets from an entity in the network and forward them to the IoT devices 110. For example, the IoT server 125 can implement a constrained application protocol (COAP) proxy to facilitate communication by resource-constrained Internet devices by translating between an IoT optimized COAP application layer protocol and a hypertext transfer protocol (HTTP).

The wireless communication system 100 includes one or more trusted authorities 135 that provide logically centralized certification of entities in the wireless communication system 100. Some embodiments of the trusted authority 135 utilize a block chain to establish trusted relationships among the entities in the wireless communication system 100. For example, the trusted authority 135 can be implemented as a distributed database that maintains a continuously growing list of ordered records called blocks, which include a timestamp and link to a previous block. Techniques for implementing block chains and using block chains to establish trusted relationships are known in the art and, in the interest of clarity, are not discussed in detail herein. The trusted relationships established by the trusted authority 135 can be leveraged to perform authentication, on boarding, access control, security verification, and other operations for the IoT devices 110.

One or more IoT proxies 140, 145 are used to aggregate information received from the IoT devices 110 for transmission to the IoT server 125, as well as distribute information received from the IoT server 125 by forwarding it to the appropriate IoT devices 110. The IoT server 125 can also support D2D communication by relaying information received from an IoT device 110 to another IoT device. Some embodiments of the IoT proxies 140, 145 are implemented in the same physical device as the IoT server 125. Some embodiments of the IoT proxies 140, 145 are implemented as network programmed middleware that is configured to perform authentication, on-boarding, access control, or security operations for the IoT devices 110. The IoT proxies 140, 145 also perform protocol, session, and security translation for packet flows between the IoT devices 110 and the IoT server 125, as well as performing bridging between IoT devices 110 and the IoT server 125. The IoT proxies 140, 145 can maintain session information for full transport sessions (e.g., TCP or UDP sessions) on behalf of the IoT devices 110 with the IoT server 125. The IoT proxies 140, 145 also support lightweight protocols that are used in packet flows to/from the IoT device 110. For example, the lightweight protocols can be light weight versions of TCP or UDP. The IoT proxies 140, 145 are also configured to map packets involving the IoT devices 110 into transport sessions with the IoT server 125. For example, the IoT proxies 140, 145 can append transport/IP headers to packets received from the IoT devices 110 before forwarding the packets to IoT server 125. The IoT proxies 140, 145 are also able to maintain per-flow per session state information on behalf of IoT devices 110. The session state information can include cookies, security keys, and the like.

Some embodiments of the IoT proxies 140, 145 are also configured to selectively support reliable delivery using retransmission protocols. For example, header information in the packets can indicate whether the packet is expected to be transmitted reliably or not. If the packet is expected to be transmitted reliably, the IoT proxies 140, 145 transmit acknowledgment (ACK/NACK) messages in response to receiving packets and support retransmission of unsuccessfully received packets. The IoT proxies 140, 145 can also be configured to ensure secure data transfers to/from the IoT device 110 using secure key management, encryption, decryption and integrity checks. Some embodiments of the IoT proxies 140, 145 are configured to multiplex sessions from multiple IoT devices 110 to the same IoT server 125. The IoT proxies 140, 145 are also able to offload compute, memory, or network resources from the IoT devices 110 to the IoT proxies 140, 145. Some embodiments of the IoT proxies 140, 145 also support seamless handoff during mobility of the IoT devices 110, e.g., by migrating session state information and security context migration between IoT proxies 140, 145 in response to an IoT device 110 handing off from a base station 101 served by the IoT proxy 140 to a base station 103 served by the IoT proxy 145.

The IoT proxies 140, 145 establish a first set of sessions that are terminated by the IoT proxies 140, 145 and the IoT devices 110, respectively. For example, each of the IoT devices 110 can establish a session that is terminated by one of the IoT proxies 140, 145. The sessions operate according to a first protocol, which is referred to hereinafter as “a shim protocol.” In some embodiments, the sessions are configured to support connectionless communication with the IoT devices 110 according to the shim protocol. As used herein, the term “connectionless” refers to a data transmission method in which packets are individually addressed and routed based on information carried in the packet, rather than in the setup information of a prearranged, fixed data channel as in connection-oriented communication. Connectionless communication can be performed using a pre-provisioned connection that is available to the IoT devices 110 prior to the IoT devices 110 transmitting a packet (or a packet of a flow). Thus, in connectionless mode, routing or forwarding of a packet (or packets of a flow) does not require first setting up a connection for the packet (or the flow). Packets can therefore be conveyed between the IoT proxies 140, 145 and the IoT devices 110 without prior arrangement. The IoT proxies 140, 145 also establish a second set of sessions that are terminated by the IoT proxies 140, 145 and the IoT server, respectively. Thus, the first set of sessions are used to convey information between the IoT devices 110 and the IoT proxies 140, 145 and the second set of sessions are used to convey information between the IoT proxies 140, 145 and the IoT server 125.

The IoT devices 110 associated with each of the base stations 101-103 share logical links that are terminated by the IoT proxies 140, 145 on one end and by the switches 111-113 on the other end. The first set of sessions between the IoT proxies 140, 145 and the IoT devices 110 can therefore utilize the logical links to convey packets. In some embodiments, the logical links are implemented using tunnels 151, 152, 153, 154 (collectively referred to herein as “the tunnels 151-154”) to create layer 2 connectivity between the switches 111-113 and the IoT proxies 140, 145. For example, the tunnels 151-154 can be configured based on MPLS/VLAN for a layer 2 network or VxLAN for a layer 3 network. The tunnels 151-154 are pre-provisioned and consequently there is no additional overhead due to tunnel set up signaling or additional delays required to forward packets. A single tunnel can carry data from multiple sessions, flows, or IoT devices 110. Although each of the tunnels 151-154 is associated with a single base station 101-102 in FIG. 1, the tunnels 151-154 or other logical links terminated by the IoT proxies 140, 145 can be associated with multiple base stations. Checksums can be inserted in packet headers at either end of the tunnels 151-154 during tunnel encapsulation, which allows the receiver to detect and discard corrupted packets, as well as eliminating any need for checksums to be carried in shim protocol packet headers.

The switches 111-113 can be associated with one or more of the IoT proxies 140, 145. For example, the switch 112 establishes a logical link via the tunnel 152 with the IoT proxy 140 and another logical link via the tunnel 153 with the IoT proxy 145. The switches 111-113 tunnel uplink traffic that is received from the IoT devices 110 to the IoT proxies 140, 145 using the pre-provisioned tunnels 151-154. Each of the switches 111-113 can be associated with a default one of the IoT proxies 140, 145, in which case uplink traffic is tunneled to the default IoT proxy over the corresponding pre-provisioned tunnel. During handoff of an IoT device 110, the SDN control unit 120 can modify the default IoT proxies 140, 145 for the switches 111-113 by modifying flow entries, e.g., in the flow table 115. For example, the SDN control unit 120 can modify a default proxy for flows associated with an IoT device 110 in response to the IoT device 110 handing off from a base station 101 served by the IoT proxy 140 to a base station 103 served by the IoT proxy 145. Downlink packets received at the IoT proxies 140, 145 are forwarded to the corresponding IoT devices 110 via the tunnels 151-154 associated with the IoT devices 110.

The IoT proxies 140, 145 are configured to store session state information that defines contexts for flows associated with the IoT devices 110. The session state information is used to construct appropriate headers for downlink packets that are conveyed from the IoT proxies 140, 145 to the base stations 101-103 for transmission to the IoT devices 110. The IoT proxies 140, 145 can also store session state information to define contexts for sessions between the IoT proxies 140, 145 and the IoT server 125 (or other servers). The session state information can include cookies, sequence numbers for an automatic repeat request protocol, security contexts for packets transmitted via the session, and the like. The IoT proxies 140, 145 are also configured to store network state information that defines contexts for the flows associated with the plurality of IoT devices 110 that share a session terminated by the IoT proxies 140, 145 and the IoT server 125. The IoT proxies 140, 145 are configured to modify headers of packets associated with the IoT devices 110 based the session state information or the network state information, as discussed herein.

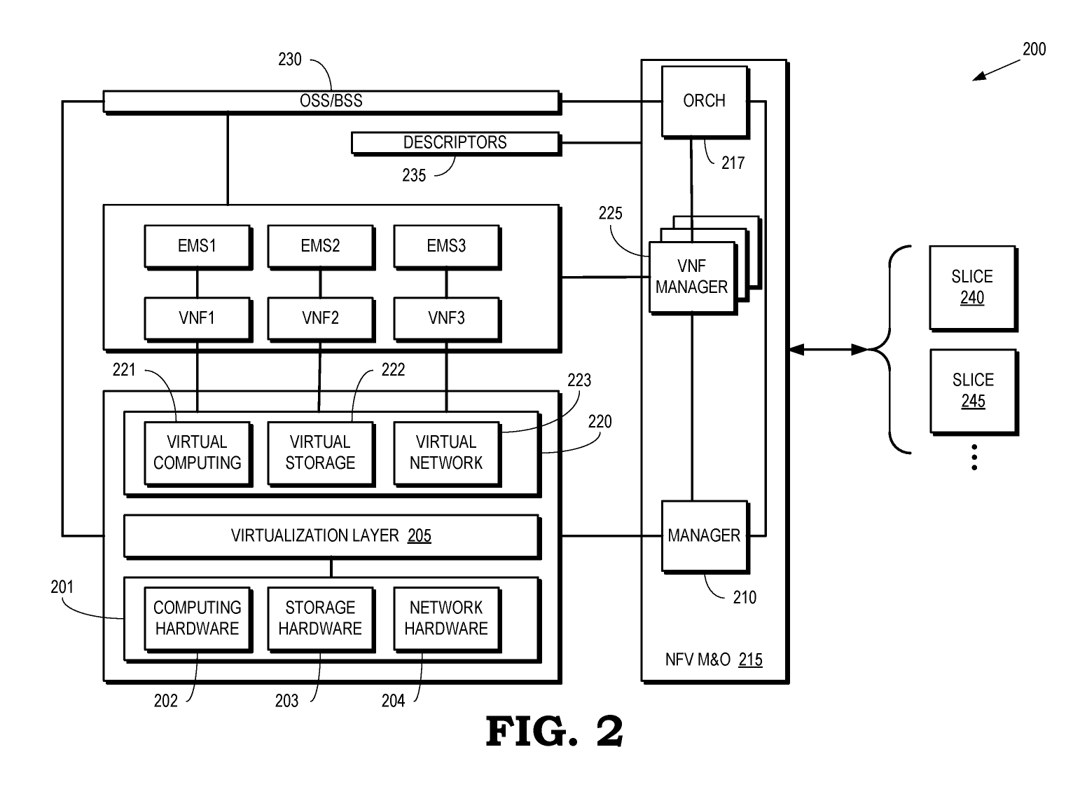

FIG. 2 is a block diagram of a network function virtualization (NFV) architecture 200 according to some embodiments. The NFV architecture 200 is used to implement some embodiments of the communication system 100 shown in FIG. 1. The NFV architecture 200 includes hardware resources 201 including computing hardware 202, storage hardware 203, and network hardware 204. A virtualization layer 205 provides an abstract representation of the hardware resources 201. The abstract representation supported by the virtualization layer 205 can be managed using a virtualized infrastructure manager 210, which is part of the NFV management and orchestration (M&O) module 215. Some embodiments of the manager 210 are configured to collect and forward performance measurements and events that may occur in the NFV architecture 200. For example, performance measurements can be forwarded to an orchestrator (ORCH) 217 implemented in the NFV M&O module 215. The hardware resources 201 and the virtualization layer 205 are used to implement virtual resources 220 including virtual computing resources 221, virtual storage resources 222, and virtual networking resources 223.

Virtual networking functions (VNF1, VNF2, VNF3) run over the NFV infrastructure (e.g., the hardware resources 201) and utilize the virtual resources 220. For example, the virtual networking functions (VNF1, VNF2, VNF3) can be implemented using virtual machines supported by the virtual computing resources 221, virtual memory supported by the virtual storage resources 222, or virtual networks supported by the virtual network resources 223. Element management systems (EMS1, EMS2, EMS3) are responsible for managing the corresponding virtual networking functions (VNF1, VNF2, VNF3). For example, the element management systems (EMS1, EMS2, EMS3) can be responsible for fault and performance management. In some embodiments, each of the virtual networking functions (VNF1, VNF2, VNF3) is controlled by a corresponding VNF manager 225 that exchanges information and coordinates actions with the manager 210 or the orchestrator 217.

The NFV architecture 200 includes an operation support system (OSS)/business support system (BSS) 230. The OSS/BSS 230 deals with network management including fault management using the OSS functionality. The OSS/BSS 230 also deals with customer and product management using the BSS functionality. Some embodiments of the NFV architecture 200 use a set of descriptors 235 for storing descriptions of services, virtual network functions, or infrastructure supported by the NFV architecture 200. Information in the descriptors 235 may be updated or modified by the NFV M&O 215.

One or more network slices 240, 245 are implemented using the NFV architecture 200. As used herein, the term “network slice” refers to a logical instantiation of a network. The network slices 240, 245 are logical instantiations of different networks that run concurrently on the hardware resources 201 of the NFV architecture 200, including the computing hardware 202, storage hardware 203, and network hardware 204. The network slice 240 is optimized for IoT by implementing a connectionless core network that includes the tunnels 151-154 and the IoT proxies 140, 145 shown in FIG. 1 and an edge slice (not shown) that is optimized for video delivery with a connection-oriented core network. The IoT traffic is therefore provided with highly scalable fast delivery, low latency, and high reliability. The network slice 245 can be optimized for providing conventional broadband service to the user equipment. Additional network slices to support the same or different types of networks can also be implemented using the NFV architecture 200.

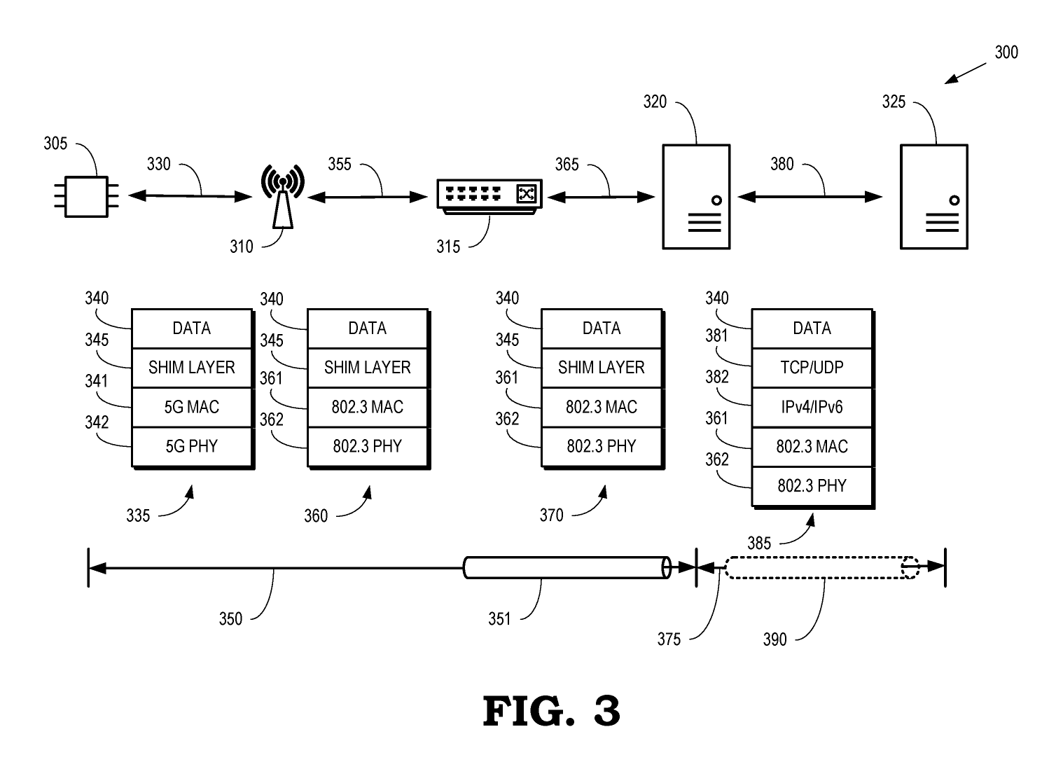

FIG. 3 is a block diagram that illustrates protocol stacks for interfaces between entities in a wireless communication system 300 that provides wireless connectivity to one or more IoT devices 305 according to some embodiments. The wireless communication system 300 includes a base station 310, a switch 315, an IoT proxy 320, and an IoT server 325. The wireless communication system 300 can therefore be implemented in some embodiments of the wireless communication system 100 shown in FIG. 1.

The IoT device 305 communicates with the base station 310 over an air interface 330. The IoT device 305 and the base station 310 therefore implement a protocol stack 335 to facilitate communication over the air interface 330. The protocol stack 335 includes a data layer 340 for identifying relevant protocols and encapsulating packets according to the protocols, a media access control (MAC) layer 341 for controlling how the IoT device 305 gain access to the air interface 330, and a physical (PHY) layer 342 that defines the electrical and physical characteristics of the data connection via the air interface 330. In the illustrated embodiment, the layers 341, 342 implemented according to Fifth Generation (5G) standards.

The protocol stack 335 also includes a shim layer 345 that supports a lightweight transport protocol defined for a session 350 between the IoT device 305 and the IoT proxy 320. The session 350 can utilize a logical link 351 (such as a tunnel) that is established between the switch 315 and the IoT proxy 320. Although a single session 350 shown in FIG. 3, the logical link 351 can be shared by multiple sessions associated with multiple IoT devices. The shim layer 345 carries enough session state to handle routing and transport of packets to/from the IoT server 325, as well as carrying the security context between the IoT device 305 and the IoT Proxy 320. The session state includes compressed identifiers (for the IoT device 305 and the IoT server 325), which are used by the end points (e.g. IoT proxy 320 or the IoT device 305) for processing and forwarding the packet to/from an IoT application in an application layer (not shown). The session state also includes protocol flags, sequence numbers for packet retransmission, packet integrity data, and the like. The shim layer 345 is not processed by the network between the IoT Device 305 and the IoT proxy 320. Data frames are carried in packets over the 5G MAC layer 341 and the PHY layer 342. Packet payloads include the shim layer 345 along with application data. The payload data can be encrypted according to an encryption used between the IoT device 305 and the IoT proxy 320. The 5G MAC and PHY headers in the packet include the source address/device ID (e.g. IMSI) of the IoT device 305, as well as additional tags (e.g. VLAN tags) to convey information about destination, the quality-of-service (QoS) treatment, the network slice for the packet flow/session, and the like.

The base station 310 communicates with the switch 315 over wired or wireless interfaces 355. The base station 310 and the switch 315 therefore implement a protocol stack 360 to facilitate communication over the interface 355. The protocol stack 360 includes a data layer 340 and a shim layer 345. The shim layer 345 and payload data are forwarded without any modifications from the network stack 335. The protocol stack 360 also includes a MAC layer 361 and a PHY layer 362 that are implemented according to 802.3 standards. Thus, packets are forwarded (or received) by the base station 310 as an Ethernet (802.3) frame over a layer 2 network to (or from) the IoT proxy 320. The base station 310 maps between the 5G MAC and 802.3 MAC packet headers based on a device ID and other tags that are carried in the 5G MAC in one direction and based on the 802.3 MAC header in the other direction. The 802.3 packet from base station 310 to the switch 315 can include additional tags (e.g. VLAN tags) besides the regular source and destination MAC addresses.

The switch 315 and the IoT proxy 320 communicate via an interface 365 according to a protocol implemented in a protocol stack 370, which includes a data layer 340, a shim layer 345, an 802.3 MAC layer 361, and an 802.3 PHY layer 362. In some embodiments, the logical link to the IoT proxy 320 can be implemented using a tunnel 351 between the switch 315 and IoT proxy 320, as discussed herein. Thus, the switch 315 can forward IoT packets received from the base station 310 to the IoT proxy 320. Uplink packets are forwarded over layer 2 (e.g. switching is based on 802.3 MAC headers and via VxLAN/GRE tunnels). In some embodiments, the packets have VLAN tags to determine the logical link on which they should be forwarded. The switch 315 can select the IoT proxy 320 based on flow entries set in the switch 315 by an SDN control unit such as the SDN control unit 120 shown in FIG. 1. For example, choosing the IoT proxy 320 can involve matching on the source address (e.g. MAC assigned to the IoT device 305 by the base station 310) and the tags in the 802.3 MAC header to select the appropriate QoS, network slice and IoT proxy 320 for the packets. The IoT proxy 320 forwards downlink packets using layer 2 forwarding over the tunnel 351 to the switch 315.

The IoT proxy 320 translates between protocols used for the session 350 and a session 375 that is established over an interface 380 between the IoT proxy 320 and the IoT server 325. In some embodiments, the session 375 is implemented using a tunnel 390. The shim layer 345 is not included in a protocol stack 385 that is used for communication over the interface 380. Instead, the protocol stack 385 implements a TCP or UDP layer 381 and an Internet protocol layer (IPv4 or IPv6) 382, in addition to the data layer 340, 802.3 MAC layer 361, and 802.3 PHY layer 362. In some embodiments, the IoT proxy 320 performs packet translations to bridge between the shim layer 345 on one side and the full network stack (e.g. routing and transport headers defined by the layers 381, 382) on the other side. The IoT proxy 320 checks received uplink packets for integrity based on the packet integrity data included in the shim layer 345, decrypts the uplink packet (if security is turned on), removes the shim layer, and extracts the payload from the packet. The payload is copied to a new packet and full routing and transport headers are added.

The packet is sent over the interface 380 according to a standard connectionless (e.g. UDP) or connection oriented (e.g. TCP) protocol to the IoT server 325. The packet can be selectively forwarded over the interface 380 based on the results of the integrity check if an integrity check is performed by the IoT proxy 320. For example, the packet is forwarded over the interface 380 if integrity of the packet is validated based on the integrity check. In order to support translation to a connection-oriented protocol, the IoT proxy 320 maintains all the session state (e.g. TCP state) for the connection with the IoT server 325. Similarly, in the other direction, network headers are removed from packets received by the IoT proxy 320 from the IoT server 325 (e.g. over UDP) and the payload in the packets is copied to a new packet. The IoT proxy 320 appends a shim layer header 345 to the packet, which is then forwarded to the IoT device 305 via the session 350. The IoT proxy 320 also maintains any session state (e.g. sequence numbers, security context) that is necessary for reconstructing the shim layer headers.

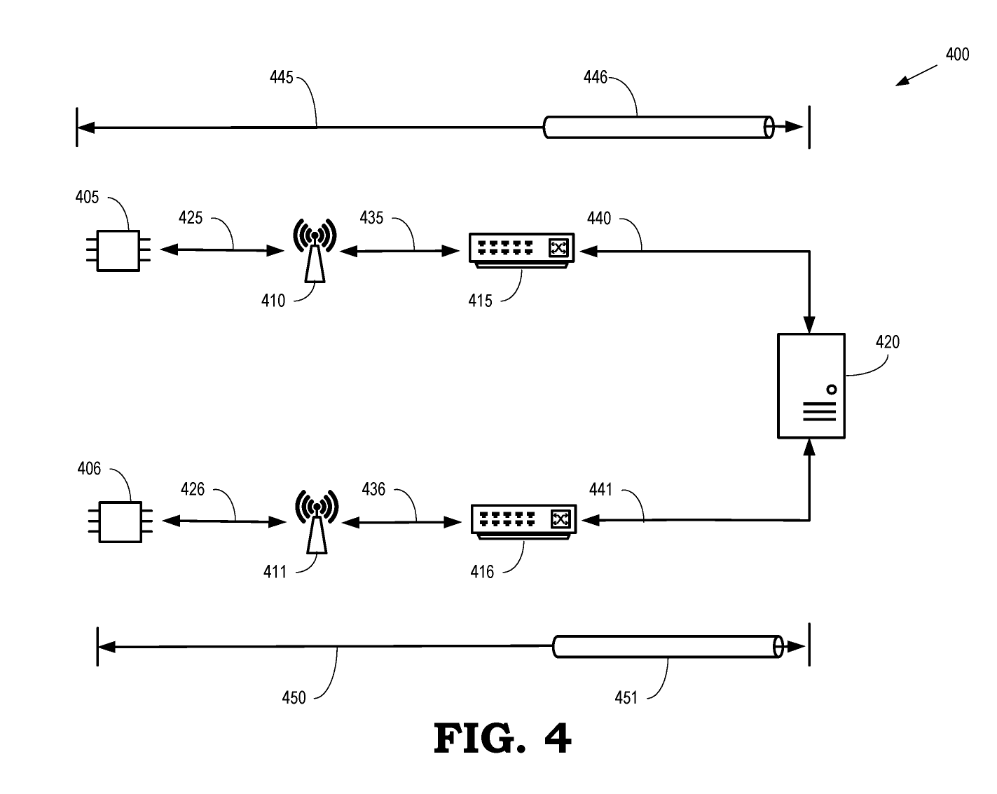

FIG. 4 is a block diagram that illustrates interfaces that are used to support D2D communication in a wireless communication system 400 according to some embodiments. The wireless communication system 400 includes IoT devices 405, 406, base stations 410, 411, switches 415, 416, and IoT proxy 420. The wireless communication system 400 can be implemented in embodiments of the wireless communication system 100 shown in FIG. 1 that support D2D communication.

In D2D communication, the IoT device 405 communicates with the base station 410 over an air interface 425, e.g., in a connectionless mode. Communication over the air interface 425 can be performed on the basis of a protocol stack implemented in the IoT device 405 and the base station 410, such as the protocol stack 335 shown in FIG. 3. Similarly, the IoT device 406 communicates with the base station 411 over an air interface 426 on the basis of a protocol stack implemented in the IoT device 406 and the base station 410, such as the protocol stack 335 shown in FIG. 3.

The base station 410 communicates with the switch 415 over a wired or wireless interface 435 on the basis of a protocol stack implemented in the base station 410 and the switch 415, such as the protocol stack 360 shown in FIG. 3. Similarly, the base station 411 communicates with the switch 416 over a wired or wireless interface 436 on the basis of a protocol stack implemented in the base station 411 and the switch 416, such as the protocol stack 360 shown in FIG. 3.

The switch 415 communicates with the IoT proxy 420 over a wired or wireless interface 440 on the basis of a protocol stack implemented in the switch 415 and the IoT proxy 420, such as the protocol stack 370 shown in FIG. 3. Similarly, the switch 416 communicates with the IoT proxy 420 over a wired or wireless interface 441 on the basis of a protocol stack implemented in the switch 416 and the IoT proxy 420, such as the protocol stack 370 shown in FIG. 3.

The protocol stacks used to implement the interfaces 425, 435, 440, include a shim layer that supports a lightweight transport protocol defined for a session 445 between the IoT device 405 and the IoT proxy 420. Some embodiments of the session 445 utilize a logical link 446 (such as a tunnel) that is established between the switch 415 and the IoT proxy 420, as discussed herein. Although a single session 445 is shown in FIG. 4, the logical link 446 can be shared by multiple sessions associated with multiple IoT devices. Similarly, the protocol stacks used to implement the interfaces 426, 436, 441, include a shim layer that supports the lightweight transport protocol defined for a session 450 between the IoT device 406 and the IoT proxy 420. Some embodiments of the session 450 utilize a logical link 451 (such as a tunnel) that is established between the switch 416 and the IoT proxy 420, as discussed herein. Although a single session 450 is shown in FIG. 4, the logical link 451 can be shared by multiple sessions associated with multiple IoT devices.

The operation of the IoT proxy 420 differs from the operation of the IoT proxy 320 shown in FIG. 3 because the IoT proxy 420 does not need to remove the shim header or translate to a protocol used by another server in a network. Instead, IoT proxy modifies the shim header based on session information for the other session. The IoT proxy 420 can forward packets received from the IoT device 405 via the logical link 440 to the IoT device 406 via the logical link 450, and vice versa. Some embodiments of the IoT proxy 420 perform integrity checks on packets received via the logical links 440, 450 on the basis of integrity data included in the packets. The IoT proxy 420 only forwards packets that pass the integrity check.

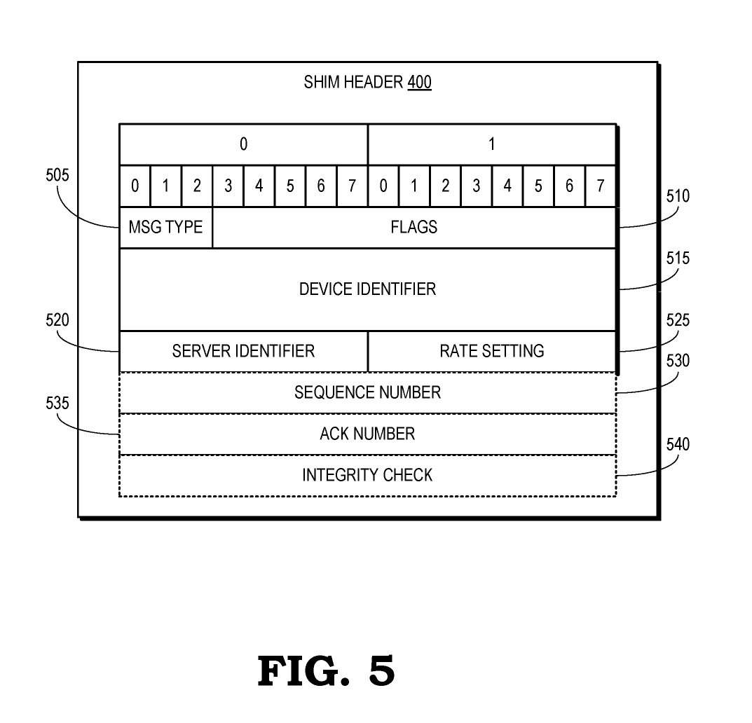

FIG. 5 is a block diagram of a shim header 500 that is appended to packets transmitted between IoT devices and an IoT proxy according to some embodiments. The shim header 500 can range in size from 7 to 18 bytes, although other embodiments of the shim header 500 can use different numbers of bytes. The seven byte size header is used when neither reliability nor security are needed, in which case it is not necessary to include an ACK field or an integrity check field in the shim header 500. On the other hand, when reliability is required and packets need to be checked for integrity, the additional fields are included in the shim header 500 so that the size of the shim header can increase to 18 bytes. The presence (or absence) of optional fields in the shim header 400 is conveyed by setting corresponding values of bits that represent flags.

The shim header 500 includes a message type (MSG TYPE) field 505 that includes bits having values that represent a type of a message. In some embodiments, there are 16 different types of messages. Three of these message types are used for data packets and the others are for control packets such as control messages that are transmitted between the IoT devices and the IOT proxy including for authentication, and the like. The different types of data packet only differ in their server identifier field as described below.

The shim header 500 also includes a flag field 510 that includes bits representative of a set of flags. Examples of the flags that are included in the flag field 510 include:
a. a flag indicating whether reliability is required (One Bit)
b. a flag indicating whether an ACK is included (One Bit)
c. a flag indicating whether an integrity check is included One Bit)
d. a flag indicating whether a Rate Control Setting is included (One bit)
e. a Retransmission Count (RC, three bits). If RC=n, then n>0 implies this is the n-th retransmission of the packet with this sequence number. If n=0 then this is an original transmission and not a retransmission (packet is being sent the first time).

The shim header 500 further includes a device identifier field 515, which includes a set of bits that represent a unique identifier (in the namespace of the IoT proxy) that is assigned to the device by the IoT proxy. In the illustrated embodiment, the device identifier field 515 includes four bytes so that each IoT proxy can assign a unique identifier to up to four billion IoT devices. If the IoT device is capable of IP networking, then the address indicated in the device identifier field 515 can be equal to the IP address of the IoT device. Otherwise, the IoT proxy can assign each active IoT device an IP address from a pool of IP addresses. The IoT proxy also maintains a mapping from the device identifier 515 to the IP address of the IoT device. The IP address for the IoT device (whether directly or indirectly obtained from the device identifier field 515) is included in packets sent by the IoT proxy on behalf of the IoT device to an IoT server.

The shim header 500 further includes a server address field 520, which includes a set of bits that represent an IoT server that provides applications or services to the IoT device indicated in the device identifier field 515. As mentioned above, some embodiments support three different data packet types and each data packet type has a different type of server address. For example, there can be different data packet types can use different identifiers such as:
a. A compressed one byte server identifier. In this case, at any given time the IoT device is able to concurrently connect to 256 different applications/services. For each IoT device, the IoT proxy maintains a mapping from this one byte server identifier in the shim layer header 500 to the actual (uncompressed) identifier (e.g. IP address and port number) of the application that is referred to by the identifier. This packet type is used when the IoT device is not capable of IP networking.
b. A three byte server identifier that includes a compressed two byte server address (e.g. compressed IP address) and a compressed one byte application identifier on the server (one byte port). A three byte server identifier is used when an IoT device can concurrently connect to many different applications on an IoT server. The IoT Proxy is responsible for mapping between the value of the server identifier 520 in the shim header 400 and the actual address of the application.
c. A five byte server identifier that includes a four byte address (e.g. IP address) and a one byte port number (only at most 256 pre-defined values that map to well known application port numbers are allowed). If an IP address is used then it may be the actual IP address of the IoT server.

The shim header 500 further includes a rate setting field 525 that is used for congestion control. In some embodiments, the IoT proxy requires that the IoT device adjusts its data transmission rate according to the value of the rate setting field 525 during congestion.

The shim header 500 optionally includes a sequence number field 530 that is used during retransmission. As discussed above, a flag in the flag field 510 can be set to a value to indicate that reliability is required for the packet. If the flag is set to indicate reliability, retransmission of unsuccessfully received packets is enabled between the IoT device and the IoT proxy. The shim header 500 then incorporates the sequence number field 530, which can be a two byte sequence that is sufficiently long to represent sequence numbers for short lived sessions used for sending short packet bursts. A value of the sequence number field 530 increments by one every time a new packet is sent by the IoT device (for retransmission the original sequence number is used). The sequence number is also incremented by one every time the IoT proxy transmits (or retransmits) a packet. The values of the sequence numbers indicated in the sequence number field 530 are used to identify missing/lost packets. The changing sequence numbers in the sequence number field 530 can also provide additional security during encryption so that different packets that have identical payloads end up with different payloads after encryption. The sequence number field 530 is not included in the shim header if the corresponding flag in the flag field 510 is set to a value to indicate that reliability is not required for the packet.

The shim header 500 optionally includes an acknowledgment (ACK) number field 535. As discussed above, a flag in the flag field 510 can be set to indicate whether an acknowledgment number is included in the shim header 500. If the flag is set to a value that indicates that the acknowledgment number is included, the shim header 500 includes the ACK number field 535, which can be two bytes that represent the ACK number associated with the packet. The value in the ACK number field 535 is used in conjunction with the value in the sequence number field 530 to perform retransmission. If the flag in the flag field 510 is set to a value that indicates that the acknowledgment number is not included, the shim header 500 does not include the ACK number field 535.

The shim header 500 optionally includes an integrity check field 540. As discussed above, a flag in the flag field 510 can be set to indicate whether an integrity check is to be performed on the contents of the packet. If the flag is set to a value that indicates that the integrity check is to be performed, the shim header 500 includes the integrity check field 540. The contents of the integrity check field 540 are used to verify the integrity of the packet, e.g., to verify that the packet was not modified in transit by a malicious adversary. The shim header 500 does not include a checksum as a checksum is included in the tunnel headers that encapsulate frames that are transmitted between the switch and the IoT proxy, as discussed herein. Furthermore, errors in 5G frames between the IoT device and the base station can be detected and handled by the 5G MAC/PHY.

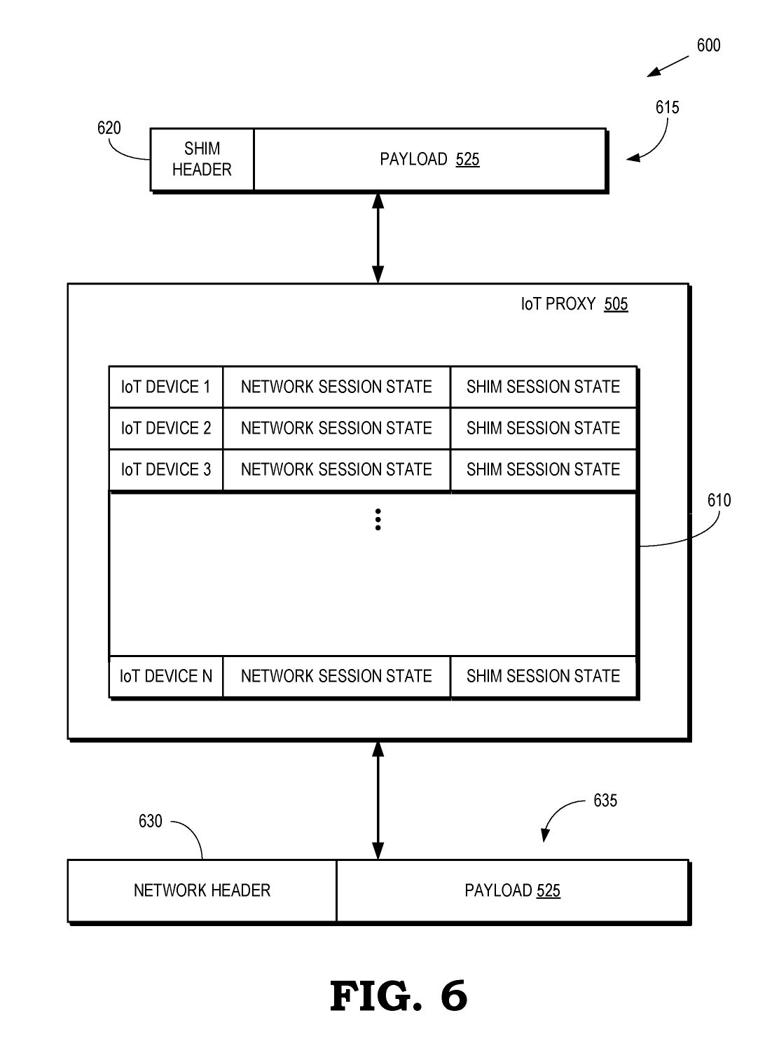

FIG. 6 is a block diagram that illustrates a packet translation process 600 performed by an IoT proxy 605 according to some embodiments. The packet translation process 600 is implemented in some embodiments of the IoT proxies 140, 145 shown in FIG. 1 and the IoT proxy 320 shown in FIG. 3. The IoT proxy 605 includes a database 610 that is used to map identifiers of IoT devices to corresponding network state information associated with packets transmitted between the IoT proxy 605 and an IoT server (not shown in FIG. 5) and shim session state information associated with packets transmitted between the IoT proxy 605 and the corresponding IoT device (not shown in FIG. 5).

The IoT proxy 605 facilitates data transfers between IoT devices and the IoT server using standard network protocols (e.g. TCP, UDP, SCTP etc.) to forward packets transmitted between the IoT proxy 605 and the IoT server. Consequently, the IoT server does not need to be modified to support the data transfers. However, due to the high overhead for IoT, the standard network protocols are not executed end-to-end between the IoT devices and the IoT server. Instead, the standard protocols are only operated between the IoT server and the IoT proxy 605, which acts as a virtual agent for the IoT devices indicated in the database 610. As discussed herein, the IoT proxy 605 implements lightweight data transfer protocols (e.g., the shim layer) for transferring packets between the IoT devices and the IoT proxy 605. The shim layer protocol is optimized for low latency, low overhead, security (e.g. resilience to attacks) and can also support reliable delivery. The shim layer protocol uses a connectionless session so that the IoT devices are able to send data without any signaling (e.g. 3 way TCP hand shake) for connection setup. The shim layer protocol also eliminates much of the overhead of higher layer networking stacks (L3 and beyond) because a relatively small shim layer header is added in addition to the L2 headers.

The IoT proxy 605 can receive a packet 615 from an IoT device. The packet 615 includes a shim header 620 and a payload 625. The shim header 620 sent by a sender (e.g. IoT device) carries enough session state to allow the receiver (e.g. IoT proxy 605) to create complete network sessions to IoT servers on behalf of the IoT device. The IoT proxy 605 strips off the shim header 620 and generates a network header 630 based on the network session state information for the IoT device in the database 610. The network header 630 is appended to the payload 625 to form a new packet 635 for transmission to the IoT server. The IoT proxy 605 performs the reverse translation on downlink packets received from the IoT server and destined for the IoT device using the shim session state information. Thus, the access network (e.g. 5G RAN) and the core SDN enabled network, including the IoT proxy 605, are able to facilitate expedited forwarding of the data between the IoT device and the IoT proxy 605 based only on the lower layer (MAC and PHY) headers. The IoT proxy 605 performs the translation using different approaches depending upon whether or not reliability is required for the payload 625 in the packets 615, 635.

In the first case, reliability is not required for the payload 625 in the packets 615, 635. In some embodiments, a reliability flag in a flag field of the shim header 620 is set to a value (such as 0) to indicate that reliability is not required. In response to receiving an uplink packet 615 from the IoT device, the IoT proxy 605 checks the uplink packet 615 for integrity, decrypts the uplink packet 615 (if security is turned on), and extracts the payload 625 from the packet 615. The payload 625 is copied to the (new) packet 635 and the IoT proxy 605 generates a network header 630 based on the information in the database 610. The IoT proxy 605 then transmits the packet 635 over a standard connectionless (e.g. UDP) protocol to the IoT server. In response to receiving a downlink packet 635 from the IoT server (e.g. over UDP), the IoT proxy 605 removes the network header 630 from the downlink packet 635, extracts the payload 625, and copies the payload 625 to a new packet 615. The IoT proxy 605 generates a shim header 620 based on the information in the database 610 and appends the shim header 620 to the packet 615, which is then transmitted to the IoT device.

In the second case, reliability is required for the payload 625 in the packets 615, 635. In some embodiments, a reliability flag in a flag field of the shim header 620 is set to a value (such as 1) to indicate that reliability is required. The second case differs from the first case (which does not require reliability) because in the second case each packet from a sender is acknowledged by a corresponding receiver. For example, the IoT proxy 605 acknowledges uplink packets 615 received from an IoT device and the IoT proxy 605 acknowledges downlink packets 635 received from the IoT server. In some embodiments, the sender uses a re-transmission timeout for the packet so that the sender retransmits the packet if the sender does not receive an acknowledgment indicating that the packet was successfully received (e.g. an ACK) within the time indicated by the re-transmission timeout. The re-transmission is performed a predetermined number of times before the sender abandons transmission of the packet. The re-transmission count field in the shim flags is used to identify the retransmission count for this retransmitted packet. The ACK packet transmitted by the receiver includes the sequence number of the last packet of the contiguous group of packets (any previous packets). For example, the sequence number and the ACK number fields in the shim header 620 can be used to indicate the sequence number of the last received packet. The sequence numbers are carried in every packet and are incremented by the sender for every new packet that it sends. The receiver can identify missing packets from any gaps in the sequence numbers. The receiver can buffer any packets with higher sequence number for a certain time period (determined based on a receive timeout) if there is a gap in the sequence number of the received packets. However, after the receive timeout the sender does not wait for the missing packet and forwards on any outstanding packets.

In the second case, the IoT proxy 605 can transfer the packet 635 over a connection oriented reliable networking protocol (e.g. TCP) to the IoT server. Some embodiments of the IoT proxy 605 maintain persistent connections with the IoT server for periods of time so that there is no connection setup delay (e.g. three-way handshake for TCP). The IoT proxy 605 can also use optimized versions of these protocols that allow sending data in connection setup messages (e.g. TCP Fast Open). Some embodiments of the IoT proxy 605 used measures of a current load on the IoT proxy 605 to determine if, and for how long, a persistent connection with the IoT server is maintained. The particular protocol (reliable or not) used may depend on the needs and capability of the IoT device as well as on the requirements of higher layer protocols (e.g. COAP).

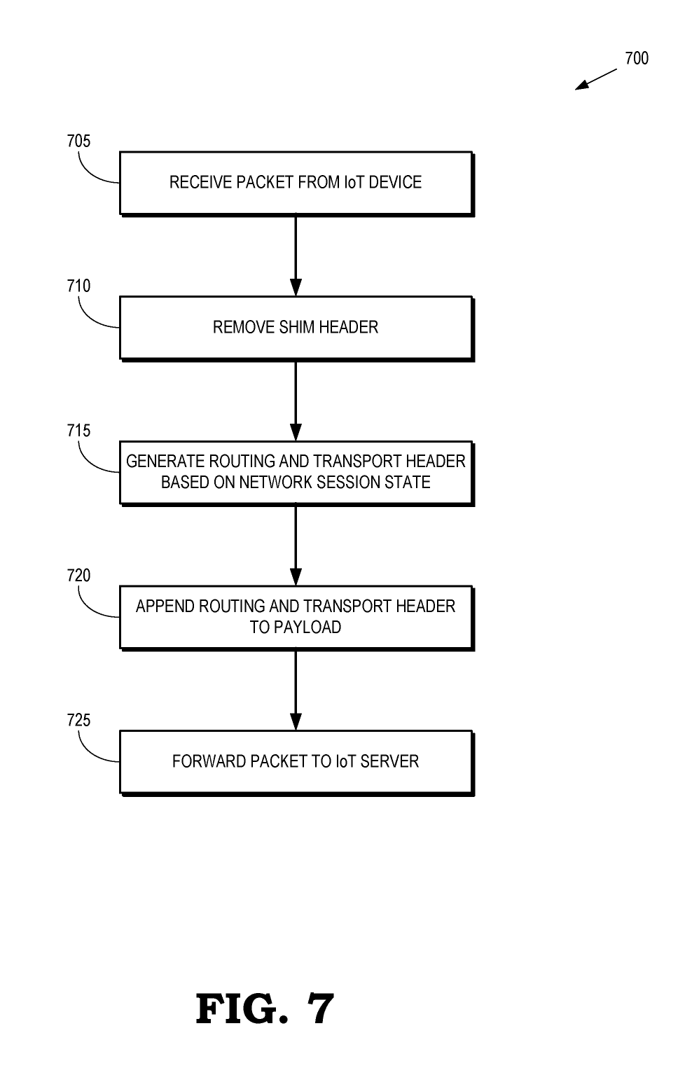

FIG. 7 is a flow diagram of a method 700 of translating uplink packets received from an IoT device to be forwarded to an IoT server according to some embodiments. The method 700 is implemented in some embodiments of the IoT proxies 140, 145 shown in FIG. 1, the IoT proxy 320 shown in FIG. 3, and the IoT proxy 505 shown in FIG. 5.

At block 705, the IoT proxy receives an uplink packet from an IoT device. As discussed herein, the uplink packet received by the IoT proxy includes a shim header and a payload. At block 710, the IoT proxy removes the shim header from the uplink packet.

At block 715, the IoT proxy generates a routing and transport header based on network session state information for the IoT device. The network session state information is maintained by the IoT proxy in a database and includes information such as a globally unique identifier of the IoT device, a mapping of a server identifier to the server, sequence numbers for an automatic repeat request protocol, security contexts for packets transmitted by the IoT device, or transmission control protocol (TCP) state information associated with a session that is terminated by the IoT proxy and the IoT server.

At block 720, the IoT proxy appends the routing and transport header to the payload to form a new uplink packet for transmission to the IoT server. At block 725, the IoT proxy forwards the new uplink packet to the IoT server using the session that is terminated by the IoT proxy and the IoT server.

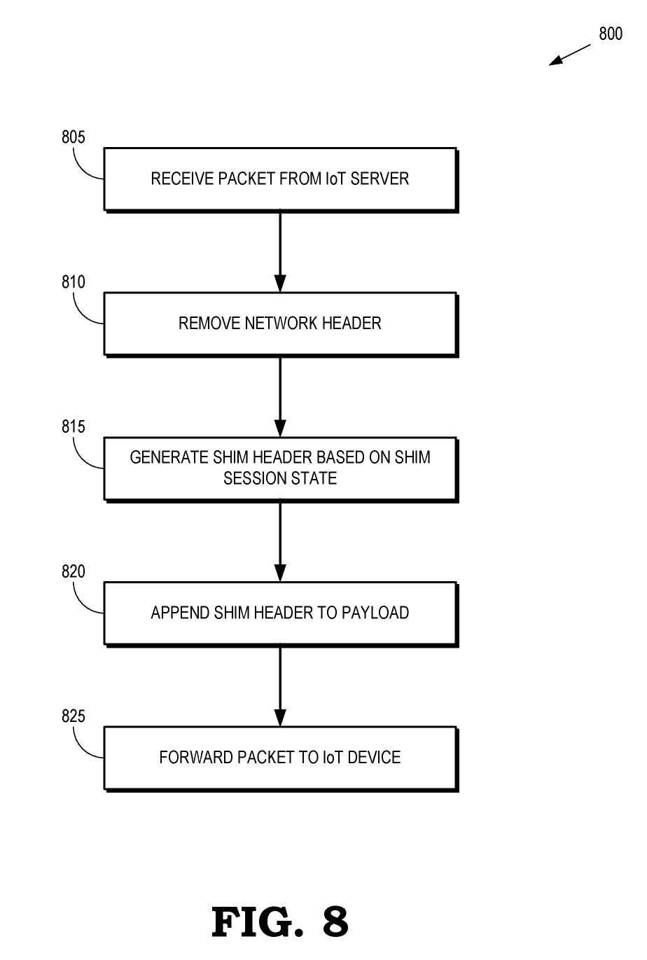

FIG. 8 is a flow diagram of a method 800 of translating downlink packets received from an IoT server to be forwarded to an IoT device according to some embodiments. The method 800 is implemented in some embodiments of the IoT proxies 140, 145 shown in FIG. 1, the IoT proxy 320 shown in FIG. 3, and the IoT proxy 505 shown in FIG. 5.

At block 805, the IoT proxy receives a downlink packet from an IoT server that is addressed to an IoT device. As discussed herein, the downlink packet received by the IoT proxy includes a network header (such as a routing and transport header) and a payload. At block 810, the IoT proxy removes the network header from the downlink packet.

At block 815, the IoT proxy generates a shim header based on shim session state information for the IoT device. The shim session state information is maintained by the IoT proxy in a database and includes information such as sequence numbers for an automatic repeat request protocol implemented for a session that is terminated by the IoT proxy and the IoT device, as well as security contexts for packets transmitted via the session.

At block 820, the IoT proxy appends the shim header to the payload to form a new downlink packet for transmission to the IoT device. At block 825, the IoT proxy forwards the new downlink packet to the IoT device using the session that is terminated by the IoT proxy and the IoT device. In some cases, the session is implemented using a tunnel that has N points at the IoT proxy and the IoT device, as discussed herein.

Implementing a shim layer to support transport of packets between an IoT proxy and an IoT device results in a significant reduction of overhead. As discussed herein, some embodiments of the shim header range in size from 7 to 18 bytes depending on the degree of reliability and security that is used to transmit the packet including the shim header. In contrast, conventional headers that can be used to transport IoT traffic require much larger headers. For example, network headers used for UDP+IPv6 and TCP+IPv4 require 48 bytes and 40 bytes, respectively. For another example, headers for IoT packets that are transported according to IPv6 over Low power Wireless Personal Area Networks (6LowPAN) protocols require 23 bytes. In some embodiments, the shim layer and corresponding shim header can be implemented in other radio access technologies, such as Wi-Fi, by using the appropriate MAC and PHY layers and headers.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
storing, at a proxy, first state information that defines first contexts for flows associated with a plurality of electronic devices, wherein the plurality of electronic devices have established a corresponding plurality of first sessions that are terminated by the proxy;
storing, at the proxy, second state information that defines second contexts for the flows associated with the plurality of electronic devices, wherein the second state information is associated with a second session that has been established between the proxy and a server or an other electronic device; and
modifying, at the proxy, headers of packets associated with the electronic devices based on at least one of the first state information or the second state information.

2. The method of claim 1, further comprising:
establishing a logical link between the proxy and a base station that serves the plurality of electronic devices prior to the base station receiving the packets, wherein the logical link is configured to provide connectionless service to the plurality of electronic devices.

3. The method of claim 2, wherein the logical link is configured to convey packets associated with the plurality of first sessions.

4. The method of claim 3, further comprising:
receiving, at the proxy, an uplink packet including a payload and a shim header from one of the plurality of electronic devices via the logical link;
removing, at the proxy, the shim header from the uplink packet;
identifying the second state information on the basis of the shim header;
generating, at the proxy, a network header based on the second state information; and
appending, at the proxy, the network header to the payload for transmission to the server or the other electronic device via the second session.

5. The method of claim 4, wherein the shim header comprises fields including information representative of a message type, at least one flag, a device identifier for the one of the plurality of electronic devices, a server identifier, and a rate setting.

6. The method of claim 5, wherein the shim header further comprises fields including information representative of at least one of a sequence number, an acknowledgment number, and integrity check information.

7. The method of claim 3, further comprising:
receiving, at the proxy, a downlink packet including a payload and a network header for one of the plurality of electronic devices via the second session;
removing, at the proxy, the network header from the downlink packet;
identifying first state information for the one of the plurality of electronic devices;
generating, at the proxy, a shim header based on the first state information for the one of the plurality of electronic devices; and
appending, at the proxy, the shim header to the payload for transmission to the one of the plurality of electronic devices via the logical link.

8. The method of claim 1, wherein storing the first state information comprises storing at least one of rate setting information to determine a data transmission rate, a server identifier for the session, sequence numbers for an automatic repeat request protocol implemented in the first session, a security context, and an integrity check for packets transmitted via the logical link.

9. The method of claim 8, further comprising:
performing integrity checks on the packets; and
selectively forwarding the packets based on results of the integrity checks.

10. The method of claim 1, wherein storing the second state information comprises storing at least one of globally unique identifiers of the plurality of electronic devices, sequence numbers for an automatic repeat request protocol implemented in the session, security contexts for packets transmitted via the session, or transmission control protocol (TCP) state information associated with the session.

11. The method of claim 1, further comprising:
assigning device identifiers to the plurality of electronic devices from a pool of device identifiers maintained by the electronic proxy; and
storing information mapping the device identifiers to globally unique identifiers of the plurality of electronic devices.

12. The method of claim 11, further comprising:
assigning a server identifier to the network entity from a pool of server identifiers for the respective electronic devices, maintained by the proxy; and
storing information mapping the server identifier to the network entity.

13. An apparatus comprising:
storage hardware configured to store:
first state information that defines first contexts for flows associated with a plurality of electronic devices, wherein the plurality of electronic devices have established a corresponding plurality of first sessions that are terminated by the apparatus; and
second state information that defines second contexts for the flows associated with the plurality of electronic devices, wherein the second state information is associated with a second session that has been established between the proxy and a server or an other electronic device; and
computing hardware configured to modify headers of packets associated with the electronic devices based on at least one of the first state information or the second state information.

14. The apparatus of claim 13, further comprising:
network hardware configured to establish a logical link between the apparatus and a base station that serves the plurality of electronic devices, wherein the logical link is configured to provide connectionless service to the electronic devices.

15. The apparatus of claim 14, wherein the logical link is configured to convey packets associated with the plurality of first sessions.

16. The apparatus of claim 15, wherein:
the network hardware is configured to receive an uplink packet including a payload and a shim header from one of the plurality of electronic devices via the logical link; and
the computing hardware is configured to remove the shim header from the uplink packet, identify the second state information based on the shim header, generate a network header based on the second state information, and append the network header to the payload for transmission to the server or the other electronic device via the second session.

17. The apparatus of claim 16, wherein the shim header comprises fields including information representative of a message type, at least one flag, a device identifier for the one of the plurality of electronic devices, a server identifier, and a rate setting.

18. The apparatus of claim 17, wherein the shim header further comprises fields including information representative of at least one of a sequence number, an acknowledgment number, and integrity check information.

19. The apparatus of claim 15, wherein:
the network hardware is configured to receive a downlink packet including a payload and a network header from one of the plurality of electronic devices via the second session; and
the computing hardware is configured to remove the network header from the downlink packet, identify first-aid information for the one of the plurality of electronic devices, generate a shim header based on the first state information, and append the shim header to the payload for transmission to the one of the plurality of electronic devices via the logical link.

20. The apparatus of claim 13, wherein the storage hardware is configured to store at least one of rate setting information to determine a data transmission rate, a server identifier for the second session, sequence numbers for an automatic repeat request protocol implemented in the first session, security contexts, and an integrity check for packets transmitted via the logical link.

21. The apparatus of claim 20, wherein the computing hardware is further configured to perform integrity checks on the packets, and wherein the networking hardware is further configured to selectively forward the packets based on results of the integrity checks.

22. The apparatus of claim 13, wherein the storage hardware is configured to store at least one of globally unique identifiers of the plurality of electronic devices, sequence numbers for an automatic repeat request protocol implemented in the session, security contexts for packets transmitted via the session, or transmission control protocol (TCP) state information associated with the session.

23. The apparatus of claim 13, wherein the computing hardware is configured to assign device identifiers to the plurality of electronic devices from a pool of device identifiers maintained by the apparatus, and wherein the storage hardware is configured to store information mapping the device identifiers to globally unique identifiers of the plurality of electronic devices.

24. The apparatus of claim 23, wherein the computing hardware is configured to assign a server identifier to the network entity from a pool of server identifiers maintained by the apparatus, and wherein the storage hardware is configured to store information mapping the server identifier to the network entity.

25. An apparatus comprising:
storage hardware, computing hardware, and network hardware configured to implement virtual storage, virtual computing, and virtual network resources that are allocated to virtual network slices, wherein virtual storage resources allocated to a first virtual network slice are configured to store:
first state information that defines first contexts for flows associated with a plurality of electronic devices, wherein the plurality of electronic devices have established a corresponding plurality of first sessions that are terminated by the apparatus; and
second state information that defines second contexts for the flows associated with the plurality of electronic devices, wherein the second state information is associated with a second session that has been established between the proxy and a server or an other electronic device; and
wherein virtual computing resources allocated to the first network slice are configured to modify headers of packets associated with the electronic devices based on at least one of the first state information or the second state information.

26. The apparatus of claim 25, wherein:
the virtual network resources allocated to the first network slice are configured to receive an uplink packet including a payload and a shim header from one of the plurality of electronic devices via a logical link; and
the virtual computing resources are configured to remove the shim header from the uplink packet, identify the second state information based on the shim header, generate a network header based on the second state information for the one of the plurality of electronic devices, and append the network header to the payload for transmission to the server or the other electronic device via the second session.
